(19) United States
(12) Patent Application Publication
(10) Pub. No.: US 2007/0156515 A1
(43) Pub. Date: Jul. 5, 2007

(54) Method for integrating attitudinal and behavioral data for marketing consumer products

(75) Inventors: Dana J. Hasselback, Neenah, WI (US); James C. Richardson, Greenville, WI (US); Christine Klaubauf, Kaukauna, WI (US); Tim Miller, Appleton, WI (US); Andy VanOfferen, Appleton, WI (US); Kim Leintz, Greenville, WI (US); Joy Jentes, Appleton, WI (US); Bart Rabas, Apppleton, WI (US); Robert A. Rothe, Appleton, WI (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 11/321,498

(22) Filed: Dec. 29, 2005

(51) Int. Cl. G06Q 30/00

(52) U.S. Cl. 705/14

(57) ABSTRACT

A method and system for marketing a consumer product is disclosed. According to the method, attitudinal information and purchase behavioral information is obtained from a plurality of consumers. For instance, consumers may be surveyed regarding their attitudes about purchasing a product category and about the amount of product contained in the product category that they purchase over a given length of time. The attitudinal data and the purchase behavioral data is then integrated together creating a plurality of consumer segments. The consumer segments are grouped together based upon commonalities. Based upon loyalty to a particular brand and a volume sales objective for the brand, increased penetration into the consumer segments may be calculated in order to meet the volume objectives. One of the consumer segments may then be targeted for marketing purposes.

### BACKGROUND OF THE INVENTION

Consumer package goods or the term CPG generally refers to products that are regularly purchased by consumers after relatively short intervals of time. Consumer products may include, for instance, food products, personal hygiene products, over the counter pharmaceuticals, paper products, diapers and related auxiliary products, adult incontinence products and the like. For example, consumer products include all different types of tissue products such as paper towels, bathroom tissue, and facial tissue.

In the relatively recent past, the number of companies producing and marketing CPG products has dramatically increased. For example, grocery stores now offer a tremendous variety of different brands for each consumer product. The consumer products vary in quality, in price, and in size.

With the increase in options for consumers, competition in the marketplace for consumer products has fiercely increased. In order to maintain or increase market share, companies that sell consumer products are spending not only more resources on media and promotions, but are also conducting greater amounts of marketing studies in order to make their advertisements and other marketing efforts more successful.

In the past, many marketing efforts were based upon market structure studies. For example, market structure studies have become a standard business practice in the consumer package goods industry. Companies, such as ACNielsen have been conducting such studies for consumer product producers. Market structure studies use behavioral household panel data to enable manufacturers to understand the way consumers purchase a given product category. Market structure studies assist companies in identifying which product attributes, such as brand, size and form, are important to consumers of the category based upon past purchase patterns.

Market structure studies, for instance, have been conducted by analyzing the reported purchase behavior of households who are part of a marketing research panel that is maintained by research companies such as ACNielsen. The goal of a market structure study is to measure consumer switching behavior and loyalty pertaining to specific product attributes and brands. General demographic information is available for each of the consumers in the panel. The consumers are then categorized to assist in devising a marketing plan for a particular product.

Although market structure studies are useful, the study sometimes makes assumptions that are not always accurate. For instance, market structure studies have a tendency to assume that all consumers within a defined category are equally attractive from a marketing perspective. As such, the studies typically do not distinguish between the different consumer attitudes that may have driven the purchase decision criteria.

In other market research embodiments, instead of analyzing consumers' past purchase patterns, consumers are surveyed to understand their attitudes when making a purchase. A consumer attitudinal survey attempts to determine the reasons behind consumer purchases. For example, a system and method for targeting consumers attitudinally is disclosed in U.S. Patent Application Publication No. US2005/0033630, which is incorporated herein by reference.

Although analysis based upon consumer purchasing habits, and surveys based upon consumer attitudes are helpful when marketing a product, a need currently exists for a new method and system that allows for an integration of all types of surveys for assisting in more efficiently marketing a consumer product for meeting desired volume and profit goals.

### SUMMARY

In general, the present disclosure is directed to a method for integrating attitudinal and behavioral data for marketing consumer products. In particular, the method and system of the present disclosure is well suited to determining a marketing strategy for a particular brand contained within a product category. The method may take into account future growth in the product category based upon population changes and marketing forecasts.

For example, in one embodiment, the method for marketing a consumer product includes the steps of collecting attitudinal data from a group of consumers and collecting purchase behavior data from the same group of consumers. The purchase behavior data is integrated with the attitudinal data to form a plurality of consumer segments with commonalities. One or more of the consumer segments is then selected as a target segment. A marketing vehicle is determined for the target segment in order to pursue volume objectives for a particular brand.

The purchase behavior data that is collected for each consumer segment will vary by category. For instance, information may be collected including the volume of a product purchased by each segment over a defined length of time and the volume of a particular brand of the product category purchased by each segment over the defined length of time. In one embodiment, the brand may be sold as a plurality of subbrands. In this embodiment, for each consumer segment, the purchase behavioral data may further include information regarding the volume of each subbrand purchased by each segment over the defined length of time. For each subbrand, a profit contribution may be determined for calculating a weighted profit contribution for each consumer segment.

In one particular embodiment, the percent loyalty of each consumer segment to the brand under investigation may be calculated for the current year and estimated for future years. Based upon estimated loyalty changes and on population growth, penetration needed to meet volume objectives may be calculated. For instance, a percent loyalty for a base year may be calculated for each segment based upon the volume of the product category purchased by each consumer segment and based upon the volume of the brand purchased by each consumer segment.

After the percent loyalty during a base year is calculated for each consumer segment, percent loyalty changes for each consumer segment may be estimated. Penetration of the brand is then calculated for each consumer segment necessary to meet a volume sales objective for the brand.

Almost a limitless variety of consumer products may be marketed according to the present disclosure. Such products may include any products that are regularly purchased by consumers over a determined length of time. In one particular embodiment, for instance, the method of the present invention may be used to market tissue products, disposable baby products, adult incontinence products, feminine hygiene products, and the like.

Other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a flow chart of one embodiment of a method for collecting attitudinal data from a group of consumers regarding a consumer product in accordance with the present disclosure; and

FIG. 2 is a flow chart of one embodiment of a method for marketing a consumer product in accordance with the present disclosure.

### DETAILED DESCRIPTION

It is to be understood by one of ordinary skill in the art that the present discussion is a description of exemplary embodiments only, and is not intended as limiting the broader aspects of the present invention.

In general, the present disclosure is directed to a method and system for marketing a consumer product. More particularly, the method and system of the present disclosure is capable of combining consumers' attitudes with how consumers actually behave in the marketplace based on the products they have purchased over a period of time. The attitudinal information of consumers indicates “why” consumers purchase a certain product. The method integrates the attitudinal and behavioral consumer components in a manner that provides optimal groups of consumers or consumer segments for target marketing purposes.

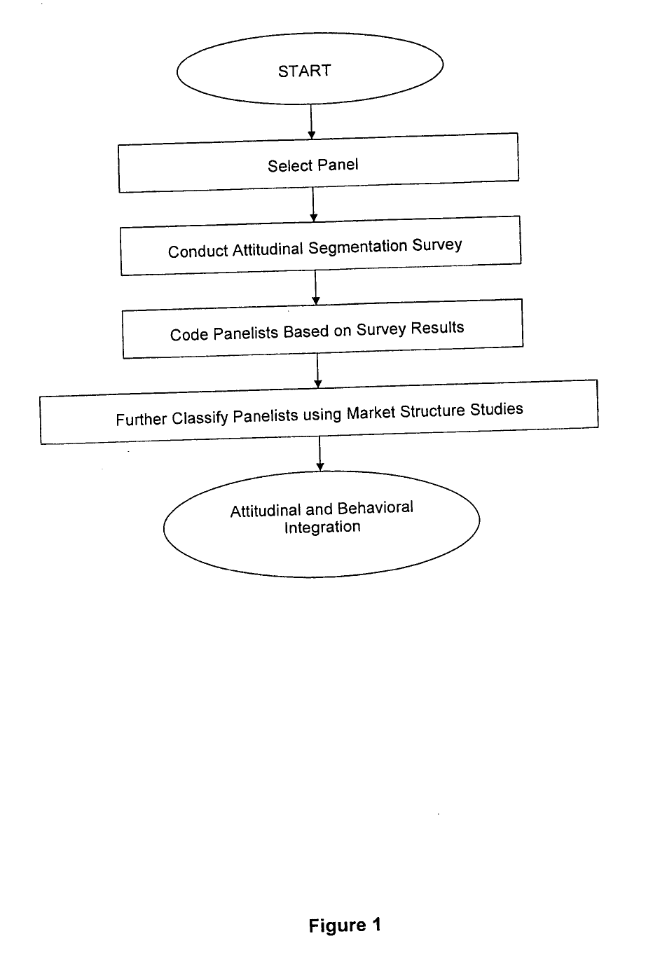

According to the present disclosure, the process begins by collecting attitudinal information from a class of consumers. For example, as shown in FIG. 1, a sample group or panel 10 of people to survey about a specific kind of product is first selected. The panel is separated through the process into groups based on attitudinal qualities. In order to identify these groups, a survey is formulated and conducted as shown at 12. The survey may include various questions that indicate the consumer's attitude towards a product. The number of questions administered to each person in the survey may vary. For instance, in one embodiment, the consumers may be asked to answer from about 5 to about 300 questions. The questions may be directed to a particular product and/or may be directed to attitudes about more general subjects. In one embodiment, for instance, the survey may include a number of statements and consumers are instructed to rate how much they agree or disagree with each particular statement on a scale of 1 to 5 (from strongly disagree to agree completely/strongly). Depending upon their answers, the consumers are divided into distinct attitudinal segments 14.

Market structure information is also collected on the panelists. As used herein, market structure information refers to information regarding consumer purchase and switching behaviors pertaining to specific products and brands. Market structure information relates to behavioral data that indicates how much of a certain product category a consumer purchases and which brands the consumer purchases. Market structure information may also relate to the size and form of the product that the consumers purchase in the category. Such studies enable manufacturers to understand the way that consumers purchase in a given product category. Specifically, market structure studies assist in identifying which product attributes (e.g., brand, size, form) are important to consumers of the category. Through market structure studies, one can determine which product attributes consumers are more loyal to and which attributes are more substitutable or less important. Ultimately, as shown in FIG. 1, the market structure information 16 may be used to further classify the panelists in creating consumer segments that include both attitudinal trends and behavioral trends or may be used to provide specific information about the attitudinal consumer segments.

The attitudinal and behavioral information that is collected is then integrated as shown at 18 in FIG. 1 and used to assist in marketing a product in conjunction with volume objectives for a particular brand. In particular, a manufacturer constructs a volume objective for a particular brand, which is based upon natural growth of the market as well as company goals. Information regarding the natural growth of the market can be obtained from Census Bureau information as well as based upon various marketing forecasts. For instance, the census results for a particular year may be used in combination with the panel results to construct a large scale estimate of the population of consumers buying a particular kind of product (category) as well as the number of consumers buying a particular brand of that product. The initial year is considered a “base year”, and by using estimations of population growth, a manufacturer may approximate how the category consumption will increase or decrease and consequently how brand consumption will increase or decrease due to the population growth alone.

In one embodiment, the results of the attitudinal and behavioral surveys may be inputted into a computing tool, such as a computer program, along with marketing forecasts and census results. The attitudinal and behavioral data may be inputted, for instance, in the different consumer segments. The consumer segments may be differentiated based on behavioral data, attitudinal data, or a combination of the two. Each segment may be based upon commonalities in response to the results. The computing tool may then be manipulated in order to predict trends in loyalty and penetration based upon the historical data. Loyalty represents the portion of a segment buyer's category volume that comes from the brand. Penetration represents the percent of households in the category that purchase, or fall into the segment. Loyalty may be calculated for each of the consumer segments identified by the attitudinal surveys, by behavioral-based information, or by a combination of the two. If desired, each segment can also be assigned a profit contribution margin, which is a number that signifies the profit that a consumer segment has to contribute to a brand relative to what other consumer segments can contribute. Profit contribution refers to the relative profitability of related products.

By inputting into the computing tool desired volume objectives or goals as well as the individual segment profit contribution, a manufacturer can identify the amount of overall profit that each consumer segment may contribute to the brand through increases in loyalty. Based on this information, the manufacturer may then market the brand to those consumer segments that will provide the most benefit to the company. By determining which consumer groups to target, a manufacturer may ultimately increase market share, penetration, loyalty, volume, and profit.

Once a particular consumer segment is selected to target, various information regarding consumers in the segment may be obtained. For example, demographic information regarding the consumer segment may be obtained. The demographic information may be obtained through the initial surveys or panel study and may be obtained from various other computing tools. For example, SPECTRA software marketed by VNU, Inc. can provide demographic detail and means to specifically reach desired segments. Various other commercially available products may also assist in determining the best way to market the particular consumer segment.

Once marketing initiatives are decided upon for a particular consumer segment, ongoing tracking of the segment may be performed using further panel data to determine if the marketing efforts had the desired result. As an example, if the brand objective was to increase loyalty in a specific consumer segment and marketing efforts were in place to achieve that effect, post measurement would determine if the marketing efforts were successful. For exemplary purposes only and for the purpose of better explaining the present disclosure, the following example illustrates how attitudinal and behavioral information can be integrated in order to assist in marketing a consumer product.

As described above, the process of the present disclosure begins with collecting attitudinal information regarding a group of consumers that purchase from a particular product category. For example, in order to obtain accurate information, the consumers subject to the survey may be required to have purchased a certain quantity of a product within a certain period of time. Further, various organizations and companies can be used to assist in selecting the consumers and administering the survey. For example, ACNielsen already has access to tens of thousands of households who agree to record their purchase behavior for marketing research purposes.

The number of consumers that take part in the survey may vary depending upon the particular product or brand that is to be marketed. For example, in one embodiment, at least 1,000 consumers may take part in the attitudinal survey, such as at least 10,000 consumers, such as at least 20,000 consumers, such as at least 40,000 consumers.

As described above, the attitudinal survey may contain numerous questions or statements that are designed to determine a consumer's attitude towards a product or category. In one embodiment, for instance, the survey may only contain ten questions or statements. For example, the following is a list of ten questions that may comprise an attitudinal survey for use with respect to the present disclosure. The following survey is directed to a specific product category. It should be understood, however, that the survey may be tailored for any particular consumer product.

A sample survey is as follows:
1-5 point rating, Strongly Disagree to Agree Completely/Strongly:
   The quality of the product is important.
   I buy products with a lower price.
   I make purchases for others.
   Higher quality products work better.
   I plan all of my purchases.
   I am an impulse buyer.

After receiving responses to the attitudinal survey, the surveyed consumers or panelists may be divided into various consumer segments that have attitudinal characteristics in common. The number of segments may vary depending upon the consumer product under investigation, the questions or statements contained in the survey, and the answers that are received. In one embodiment, for instance, the consumers who participate in the attitudinal survey may be divided into three attitudinal segments, such as Price, Premium, and Undecided. For example, Price consumers may include consumers looking for good value from the product they purchase. Premium consumers, on the other hand, are motivated more by the quality of the product than perhaps by the price. Undecided consumers, on the other hand, may be consumers that give no great thought to the purchase.

Various other attitudinal segments can also be developed based upon the particular product under investigation and the desired results. Other possible attitudinal segments may be directed towards, for instance, the emotional response of consumers towards a brand name, the emotional response of consumers to a color or to the product/packaging aesthetics, the emotional response of consumers to an aroma associated with a product, the feelings consumers have about commercials featuring the product or the brand, the role the product plays in creating a sense of wellness or cleanliness or security, etc. Of course, any other suitable attitudinal segments may be developed.

If desired, after creating the attitudinal segments, further surveys may be conducted in order to verify the segmentation.

In addition to collecting attitudinal information regarding the consumer panelists, purchase behavior information can also be gathered. When contracting marketing research companies such as ACNielsen, for instance, to administer the attitudinal survey, ACNielsen may already have or may also collect purchase behavioral information regarding the consumers. The purchase behavioral information may include the number of units each consumer purchased from within the category, and other relevant product attribute information. For example information may be gathered regarding whether the consumer purchases a single unit at a time or purchases multi-unit packs. Other behavioral information may include the purchase mix for each consumer, which comprises the brands they purchase within the category.

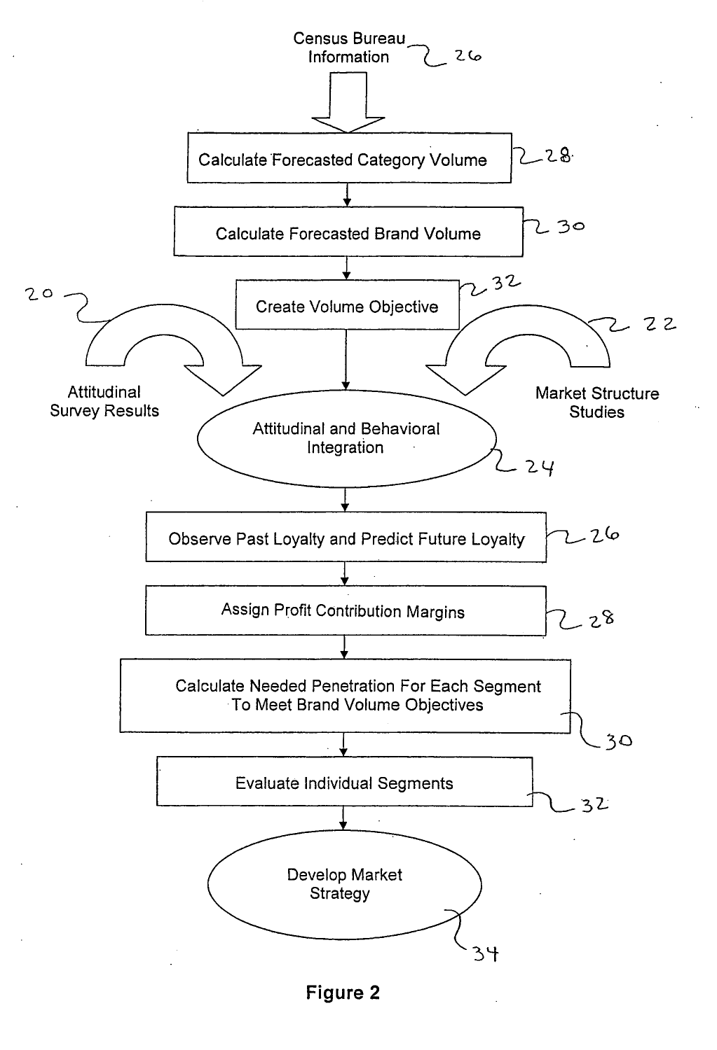

Once the attitudinal information is obtained to determine the attitudinal segments, along with the market structure information which determines purchase behavior, the data can be entered into a computing tool based upon the consumer segments that have been created. For example, referring to FIG. 2, one embodiment of a process in accordance with the present disclosure is illustrated. As shown, attitudinal survey results 20 and market structure studies 22 are integrated at 24. Integration may involve, for instance, entering into a computing tool the market structure information-based upon the consumer segments created through the attitudinal information. By entering the market structure information with attitudinal segmentation, market structure segmentation at the category level is established which can then be used to determine and identify the groups of consumers that exist in the marketplace based on commonalities.

The process or method of providing market structure information to consumer segments based upon attitude provides various other benefits in comparison to standard market structure studies done in the past. For instance, the process provides attribute ranking differences between the attitudinal groups. Further, the process layers in attitudinal information into the market structure information received. The data can also be used to identify differences in product attribute importance by attitude segments as derived from buying behavior.

The attitudinal and behavioral information can be integrated together in various ways. In one embodiment, the attitudinal and behavioral information can be combined with other information about the product category and the particular brand under investigation. For example, as shown in FIG. 2, the computing tool may also be configured to receive Census Bureau information 26 that can be used to estimate consumer population within the category. Other information that may be inputted includes forecasted category volume 28 and forecasted brand volume 30. The forecasted category volume and forecasted brand volume may be estimated based upon, for instance, the Census Bureau information and various other market factors as would be apparent to one skilled in the art. In addition to the above, the user may also input brand volume objectives as shown at 32. The computing tool can then be configured to determine category volume per household, category and brand penetration, and brand loyalty necessary to meet brand volume expectations for a given year. Of particular advantage, the loyalty and penetration objectives can be determined for each consumer segment created based upon the attitudinal information and market structure information.

In determining and setting volume growth expectations and goals for a particular brand, the method of the present disclosure takes into account that there are generally four ways that a brand can gain or lose volume: (1) more buyers can buy the product category which results in greater sales of the brand (referred to as an increase in category penetration); (2) buyers that currently purchase from the product category purchase greater volumes of the category (referred to as an increase in category consumption); (3) buyers who normally do not purchase the brand begin purchasing the brand (referred to as an increase in brand penetration); and (4) buyers who currently purchase the brand buy greater volumes of the brand to the exclusion of other brands (referred to as an increase in loyalty).

According to the method of the present disclosure, items 1 and 2 above can be predicted based upon population increases and decreases of consumers that purchase the product category and based upon market forecasts for future growth within the product category. Increases and decreases in consumer population, for instance, may be accounted for in the method by inputting Census Bureau information. Market forecasts, on the other hand, take into account past consumption of the category product in comparison to population growth. For example, if the product category volume (volume of sales) is growing faster than the target population, then forecasts assume category consumption is increasing. If, on the other hand, the product category volume is growing at a slower rate than the target population, then the category volume forecast assumes that the category consumption is decreasing.

With respect to any particular brand, the method of the present disclosure can assume that brand volume growth increases or decreases as the category volume growth increases and decreases. Thus, items 1 and 2 above are somewhat independent of any marketing efforts that a manufacturer undertakes.

Brand volume increases due to an increase in penetration and/or loyalty, on the other hand, are more directly related to the marketing efforts of the manufacturer. The method of the present disclosure by integrating attitudinal and behavioral data creates consumer segments that can be targeted in order to increase penetration and/or loyalty and maximize profit for the brand.

For exemplary purposes only, the following illustrates one embodiment of various inputs into a computing tool that can be manipulated to yield information helpful to marketing a brand. The following inputs are made after the attitudinal and behavioral information is obtained and the consumer segments as described above are created.

The first step in the process is to determine an objective or goal. The goal may be, for instance, to increase the volume of sales of a brand by a certain percentage over a certain period of time. Once an objective or goal is determined, the following inputs may be made (inputted data is underlined):

Enter INPUTS/ASSUMPTIONS

| | 2004 | | |
|---|---|---|---|
| | Base Year | 2005 | 2006 |
| Forecasted Volume | | | |
| Category Forecast | 18,158 | 19,000 | 19,050 |
| % Chg Versus Prior Year | | 4.6% | 0.3% |
| Brand Forecast | 6,355 | 6,700 | 6,800 |
| % Chg Versus Prior Year | | 5.4% | 1.5% |
| Forecasted Population Growth for | n/a | 2.00% | 0.26% |
| Target (US Census) | | | |

As shown above, the inputs include forecasted category volume, forecasted brand volume, and forecasted population growth. Marketing research, or another objective source, is used to estimate the category; the brand forecast may come from various sources, such as by being predicted internally by the company. The forecasted population growth, on the other hand, is typically based on census numbers or another objective source. It should be understood that the above numbers entered into the table are for exemplary purposes only and are not based on any true scenario.

After inputting the above information into the computing tool, the information obtained from the household panels may be inputted. First, for instance, the following information may be inputted:

Enter Base Year (2004) Household Panel Information

| | 2004 |
|---|---|
| | Base Year |
| Households (Household Panel) (in thousands) | |
| # Category HH's* (Category A) | 11,266 |
| # Segment HH's (may be same as | 11,266 |
| Category) (NA) | |
| # Brand HH (in segments) | 6,760 |
| Brand A Segment 1 | 2,313 |
| Brand A Segment 2 | 1,343 |
| Brand A Segment 3 | 2,104 |

*HH refers to Household

As shown above, in this example, 11.266 million households purchased the category. In this embodiment, the households were broken into three different consumer segments. For each consumer segment, information is inputted as to the number of households that purchase the particular brand under investigation. Although not specifically illustrated in the above example, up to nine segments may be inputted depending upon the information that is received.

Next, as shown in the following table, category and brand volume information may be inputted. During the initial year (base year), this volume comes from the same household panel that is mentioned above. Volume during the years after that are a function of growth assumptions from the forecasts entered under the forecasted volume section. As shown below, total category volume for the base year and brand volume for the base year are inputted. In addition, the brand volume purchased by each of the individual consumer segments is inputted. The brand volume is calculated by adding the segment volumes together:

Enter Base Year (2004) Volume Based On Growth Assumptions

| | 2004 |
|---|---|
| | Base Year |
| Annual HH Panel Volume Based | |
| On Growth Assumptions | |
| Total Segment/Category Volume | 7,310,876 |
| Brand Volume | 2,215,384 |
| Brand A Segment 1 | 1,308,258 |
| Brand A Segment 2 | 607,381 |
| Brand A Segment 3 | 299,745 |

As shown above, 7.3 million units of the product category were sold in the base year, while approximately 2.2 million units of the total comprise the brand volume.

Next, category consumption per household for each of the brand buying segments is inputted for the base year to allow loyalty to be calculated as follows:

Enter Base Year (2004) Consumption Per Household Info

| Average Category/Segment | 2004 |
|---|---|
| Consumption Per Household | Base Year |
| Brand A Segment 1 | 606.56 |
| Brand A Segment 2 | 922.46 |
| Brand A Segment 3 | 1032.07 |

In general, panel-based consumption is typically underreported. The panel data, however, is only used for the base year. Actual category and brand growth is applied to the base year panel volumes to tie the panel data and the forecast together.

After the category consumption per household is inputted, purchase mix/profitability assumptions may be inputted. Purchase mix refers to the fact that the brand under investigation is made up of a number of different products, each representing different profit potential for the brand. For example, if the branded product offers different package sizes each pack size variant may impact the overall profitability of the brand to a different degree. By identifying the mix of products purchased by buyers of the brand, and by doing that for each of the brand segments, we can identify if households in one segment are more likely to purchase more profitable products than households in another segment. For instance, first the subbrands may be identified as follows:

List Products for Purchase Mix/Profitability Assumptions
Subbrand 1
Subbrand 2
Subbrand 3
Subbrand 4
Subbrand 5
Subbrand 6

As shown above, in this embodiment, the brand under investigation includes six different subbrands. The portion of total brand volume that is accounted for by each subbrand is then entered for each of the consumer segments as follows:

| | Average | | | |
|---|---|---|---|---|
| Enter Base | (Applied to New | | | |
| Year (2004) | HH's Entering | Brand A | Brand A | Brand A |
| Purchase Mix | Brand) | Segment 1 | Segment 2 | Segment 3 |
| Subbrand 1 | 1.6% | 1.5% | 1.3% | 1.6% |
| Subbrand 2 | 76.0% | 81.8% | 60.0% | 76.0% |
| Subbrand 3 | 16.0% | 13.1% | 29.3% | 16.0% |
| Subbrand 4 | 4.4% | 2.7% | 7.0% | 4.4% |
| Subbrand 5 | 1.9% | 0.8% | 2.4% | 1.9% |
| Subbrand 6 | 0.1% | 0.1% | 0.0% | 0.1% |

Next, if desired, the profit contribution of each subbrand may be entered. The profit contribution provides information regarding the profitability of each subbrand. Again, this information is added based upon each of the consumer segments that have been created.

| Enter Base Year | Average (Applied | | | |
|---|---|---|---|---|
| (2004) Variable | to New HH's | Brand A | Brand A | Brand A |
| Contrib. Margin | Entering Brand) | Segment 1 | Segment 2 | Segment 3 |
| Subbrand 1 | 50.0 | 50.0 | 50.0 | 50.0 |
| Subbrand 2 | 45.0 | 45.0 | 45.0 | 45.0 |
| Subbrand 3 | 60.0 | 60.0 | 60.0 | 60.0 |
| Subbrand 4 | 75.0 | 75.0 | 75.0 | 75.0 |
| Subbrand 5 | 75.0 | 75.0 | 75.0 | 75.0 |
| Subbrand 6 | 50.0 | 50.0 | 50.0 | 50.0 |

Based upon the above information that is entered, the following interim results are obtained which reflect the profile for each of the segments in the base period:

| | | Brand A | Brand A | Brand A |
|---|---|---|---|---|
| Base Period Profile | | Segment 1 | Segment 2 | Segment 3 |
| # Households Not Buying | 48.9% | | | |
| Brand | | | | |
| Non-Brand HH Category | 453.60 | | | |
| Consumption | | | | |
| % Category Households | | 20.5% | 11.9% | 18.7% |
| % Brand Households | | 40.2% | 23.3% | 36.5% |
| % Brand Volume | | 59.1% | 27.4% | 13.5% |
| Category Consumption per | | 606.56 | 922.46 | 1032.07 |
| Household | | | | |
| Brand Consumption per | | 565.61 | 452.26 | 142.46 |
| Household | | | | |
| Loyalty | | 93.2% | 49.0% | 13.8% |
| Weighted Profit | | 48.1 | 52.3 | 49.4 |
| Contribution | | | | |

As shown, by inputting the information as described above, a base period profile may be calculated providing information on each consumer segment. As shown, in this particular embodiment, Segment 1 not only purchases the most brand volume but also has the greatest loyalty to the brand. Segment 3, on the other hand, consumes the most of the category product but shows the least amount of loyalty to the brand itself. As also shown above, a weighted profit contribution can be calculated based upon the subbrands that the consumer segments purchase.

After obtaining the base period profile as shown above, information for future periods such as future years may be inputted based upon volume objectives for the brand. For instance, the following information can be added for each succeeding year:

Enter Year 1 (2005) Information

| YEAR 1 (2005)—Loyalty Changes | Base Year | 2005 |
|---|---|---|
| Total Brand | 46.0% | 47.8% |
| Brand A Segment 1 | 93.2% | 93.2% |
| Brand A Segment 2 | 49.0% | 55% |
| Brand A Segment 3 | 13.8% | 15% |

| | Average | | | |
|---|---|---|---|---|
| | (Applied | | | |
| | to new HH's | Brand A | Brand A | Brand A |
| | entering brand) | Segment 1 | Segment 2 | Segment 3 |
| Year 1 (2005)—Pur- | | | | |
| chase Mix Based on | | | | |
| Product Groupings | | | | |
| Differentiated | | | | |
| Based on Price | | | | |
| Subbrand 1 | 1.6% | 1.5% | 1.3% | 1.6% |
| Subbrand 2 | 76.0% | 81.8% | 60.0% | 76.0% |
| Subbrand 3 | 16.0% | 13.1% | 29.3% | 16.0% |
| Subbrand 4 | 4.4% | 2.7% | 7.0% | 4.4% |
| Subbrand 5 | 1.9% | 0.8% | 2.4% | 1.9% |
| Subbrand 6 | 0.1% | 0.1% | 0.0% | 0.1% |
| Year 1 (2005)—Pro- | | | | |
| fit Contribution | | | | |
| Subbrand 1 | 50.0 | 50.0 | 50.0 | 50.0 |
| Subbrand 2 | 45.0 | 45.0 | 45.0 | 45.0 |
| Subbrand 3 | 60.0 | 60.0 | 60.0 | 60.0 |
| Subbrand 4 | 75.0 | 75.0 | 75.0 | 75.0 |
| Subbrand 5 | 75.0 | 75.0 | 75.0 | 75.0 |
| Subbrand 6 | 50.0 | 50.0 | 50.0 | 50.0 |

As shown above, for each consumer segment, loyalty changes, purchase mix, and profit contribution information can be inputted for each year included. This information is based upon goals and objectives of the manufacturer, as well as based on changes in profit contribution by subbrand. By inputting the above information, the following results may be obtained from the computing tool:

| | 2004 | | |
|---|---|---|---|
| | Base Year | 2005 | 2006 |
| Penetration Needed | 51% | 48.1 | 48.4% |
| to Meet Volume | | | |
| Obective | | | |
| Brand A Segment 1 | 20.5% | 19.3% | 19.5% |
| Brand A Segment 2 | 11.9% | 11.2% | 11.6% |
| Brand A Segment 3 | 18.7% | 17.6% | 17.7% |
| Loyalty | 46.0% | 47.8% | 48.3% |
| Brand A Segment 1 | 93.2% | 93.2% | 93.2% |
| Brand A Segment 2 | 49.0% | 55.0% | 55.0% |
| Brand A Segment 3 | 13.8% | 15.0% | 16.0% |
| Total Profit Growth | N/A | +5.6% | +1.5% |
| (Including New | | | |
| HH's) | | | |
| Planned Brand | | 5.4% | 1.5% |
| Volume Growth | | | |
| Total Households | 5,760 | 5434 | 5472 |
| Incremental | | −326 | +39 |
| Households | | | |

As shown above, based upon planned loyalty changes for each consumer segment, the penetration needed to meet the volume objectives is calculated. The needed penetration to meet volume objectives is not only based on inputted loyalty, but is also based on market forecasts and census information as described above. Of particular advantage, the needed penetration information to meet the volume objectives is broken down by the consumer segments that were created. In accordance with the present disclosure, each of the segments can be examined and one or more of the segments may be selected as a target segment for introducing a marketing campaign.

More particularly, once a particular segment is selected, greater information regarding the consumers in the segment may be collected. For example, VNU, Inc. markets a product under the tradename SPECTRA that can provide demographic information regarding the consumers in a particular segment. The SPECTRA product can also be linked to another product under the trade name Consumer Marketing Mix marketed by ACNielsen which, based upon changes in sales as a result of different marketing stimuli can identify the appropriate marketing vehicle to use for the particular segment. The marketing vehicle, for instance, may be based upon advertisements that are run on television or in various publications and/or the use of coupons or trade promotions. Of course, various other marketing vehicles may also be used.

Referring back to FIG. 2, as shown, once the attitudinal and behavioral integration 24 is completed so as to formulate various consumer segments, past loyalty is calculated and future loyalty is predicted at 26. Although optional, profit contribution 28 may be calculated, especially if the brand is sold as various subbrands. Next, penetration for each consumer segment is calculated at 30 in order to meet brand volume objectives. The individual segments are then evaluated at 32 and at least one of the segments is targeted for marketing purposes. Once a particular consumer segment is selected, a market strategy 34. may be developed based upon the commonalities of the consumers in the class. Through the process of the present disclosure, consumer segments are created and targeted that may offer the biggest benefit to the brand both from a volume as well as from a profit perspective. Each consumer segment may include consumers having commonalities that allows the marketing strategy to communicate directly to the intended class. Further, where applicable, subbrand information can be used to calculate a weighted profit contribution for each of the consumer segments. The weighted profit contribution may be used to indicate where volume increases for a particular segment are the most profitable. This information can also be balanced against loyalty information which indicates which segments have the greatest potential for volume growth.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A method for marketing a consumer product comprising:
collecting attitudinal data from a group of consumers and, based on the data, placing the consumers into attitudinal segments;
collecting purchase behavioral data from the group of consumers;
integrating the purchase behavioral data with the attitudinal data to form a plurality of consumer segments with commonalities;
selecting one of the consumer segments as a target segment; and
determining a marketing vehicle for the target segment.

2. A method as defined in claim 1, wherein, for each consumer segment, information is collected including a volume of a product category purchased by each segment over a defined length of time and a volume of a particular brand of the product category purchased by each segment over the defined length of time.

3. A method as defined in claim 2, wherein the brand comprises a plurality of subbrands and, for each consumer segment, further information is collected including a volume of each subbrand purchased by each segment over the defined length of time, for each subbrand, a profit contribution is determined for calculating a weighted profit contribution for each consumer segment based upon subbrand purchases.

4. A method as defined in claim 2, wherein, based on the volume of the product category purchased by each consumer segment and based upon the volume of the brand purchased by each consumer segment, a percent loyalty for the brand is calculated for each segment.

5. A method as defined in claim 4, wherein the percent loyalty is calculated for a defined length of time.

6. A method as defined in claim 5, wherein the defined length of time comprises the previous year.

7. A method as defined in claim 5, wherein, in selecting one of the consumer segments as a target segment, a volume sales objective for the brand is determined, percent loyalty changes for each consumer segment is estimated, and penetration of the brand is calculated for each consumer segment necessary to meet the volume sales objective taking into account the estimated percent loyalty changes.

8. A method as defined in claim 7, wherein the volume sales objective, the estimated percent loyalty changes, and the calculated penetration are for a succeeding year.

9. A method as defined in claim 1, wherein the consumer product comprises a tissue product, a disposable baby product, an adult incontinence product, or a feminine hygiene product.

10. A method as defined in claim 1, wherein from about 3 to about 9 consumer segments are formed.

11. A method as defined in claim 1, wherein the attitudinal segments comprise from about 2 to about 9 segments .

12. A method as defined in claim 1, wherein selecting one of the consumer segments as a target segment includes determining a future volume sales objective for a brand of the product and calculating the amount of penetration of the brand in each consumer segment necessary to meet the volume sales objective.

13. A method as defined in claim 1, wherein the attitudinal data is collected by administering a survey to the group of consumers.

14. A method as defined in claim 1, wherein demographic information regarding the target segment is collected in determining a marketing vehicle.

15. A method as defined in claim 1, wherein the group of consumers comprises at least about 10,000 different consumer households.

16. A method as defined in claim 7, wherein population growth is accounted for in calculating penetration for each consumer segment.

17. A method as defined in claim 12, wherein population growth is accounted for in calculating penetration for each consumer segment.

18. A method as defined in claim 7, wherein volume sales forecasts for the product category and for the brand are taken into account in calculating penetration for each consumer segment.

19. A method as defined in claim 1, wherein the attitudinal segments comprise one or more of the following: consumer attitude toward price, consumer attitude toward quality, consumer response to product or packaging aesthetics, consumer response to imagery in promotional campaigns, and consumer response to the sense of wellness or cleanliness that the product conveys.

20. A method for establishing marketing objectives for a consumer product for meeting volume and profit goals comprising:
collecting attitudinal data from a group of consumers regarding a product category of a consumer product;
collecting purchase behavioral data from the group of consumers regarding the product category and regarding a particular brand in the product category;
integrating the purchase behavioral data with the attitudinal data to form a plurality of consumer segments with commonalities;
providing a population growth forecast and volume sales forecasts for the product category and the brand;
determining a percent loyalty of the brand for each consumer segment and estimating future percent loyalty changes;
setting a future volume sales objective for the brand;
calculating penetration of the brand for each consumer segment necessary to meet the volume sales objective;
selecting one of the consumer segments as a target segment; and
determining a marketing vehicle for the target segment.

21. A method as defined in claim 20, wherein the purchase behavioral data includes a volume of the product category purchased by each consumer over a defined length of time and a volume of the particular brand of the product category purchased by each consumer over the defined length of time.

22. A method as defined in claim 20, wherein the brand comprises a plurality of subbrands and the purchase behavioral data includes a volume of each subbrand purchased by each consumer over a defined length of time, for each subbrand, a profit contribution is determined for calculating a weighted profit contribution for each consumer segment based on subbrand purchases.

23. A method as defined in claim 20, wherein from about 3 to about 9 consumer segments are formed.

24. A method as defined in claim 20, wherein the method further comprises the step of determining the market vehicle for the target segment by collecting demographic information about the target segment.

25. A method as defined in claim 20, wherein the attitudinal segments comprise one or more of the following: consumer attitude toward price, consumer attitude toward quality, consumer response to product or packaging aesthetics, consumer response to imagery in promotional campaigns, and consumer response to the sense of wellness or cleanliness that the product conveys.

26. A method for marketing a consumer product comprising:
collecting purchase behavioral data from a group of consumers regarding a product category and regarding a particular brand in the product category;
forming a plurality of consumer segments with commonalities based upon the purchase behavioral data;
providing a population growth forecast and volume sales forecasts for the product category and the brand;
determining a percent loyalty of the brand for each consumer segment and estimating future percent loyalty changes;
setting a future volume sales objective for the brand;
calculating penetration of the brand for each consumer segment necessary to meet a volume sales objective;
selecting one of the consumer segments as a target segment; and
determining a marketing vehicle for the target segment.

27. A method as defined in claim 26, wherein the purchase behavioral data includes a volume of the product category purchased by each consumer over a defined length of time and a volume of the particular brand of the product category purchased by each consumer over the defined length of time.

28. A method as defined in claim 26, wherein from about 3 to about 9 consumer segments are formed.

29. A method as defined in claim 26, further comprising the steps of collecting attitudinal data from the group of consumers and using the attitudinal data in combination with the purchase behavioral data to form the plurality of consumer segments.
